(19) United States
(12) Patent Application Publication
(10) Pub. No.: US 2025/0317518 A1
(43) Pub. Date: Oct. 9, 2025

(54) SYSTEMS AND METHODS FOR MULTIMODAL CONVERSATION SUPPORT AT A CONTACT CENTER

(71) Applicant: KORE.AI, INC., Orlando, FL (US)

(72) Inventors: RAJKUMAR KONERU, Windermere, FL (US); PRASANNA KUMAR ARIKALA GUNALAN, Hyderabad (IN); RAJAVARDHAN NALLURI, Hyderabad (IN); RUCHI GUPTA, Los Gatos, CA (US); RAVI KUMAR PINDIPOLU, Hyderabad (IN); ASHISH SANKHALA, Bengaluru (IN)

(21) Appl. No.: 18/926,813

(22) Filed: Oct. 25, 2024

Related U.S. Application Data
(60) Provisional application No. 63/631,014, filed on Apr. 8, 2024.

(51) Int. Cl. H04M 3/523; G06F 40/58; G10L 13/08; G10L 15/22; G10L 15/30; H04M 3/51

(52) U.S. Cl. CPC H04M 3/5233; G06F 40/58; G10L 13/08; G10L 15/22; G10L 15/30; H04M 3/5183

(57) ABSTRACT

A contact center server provides as part of a voice conversation with a customer device a voice prompt indicating the unavailability of any voice agent the agent devices and an option to route the voice conversation to any available chat agent at one of the agent devices. The contact center server receives a confirmation from the customer device to route the voice conversation to any available chat agent. In response to the confirmation, a multimodal communication session between the customer device and an available chat agent is established. Subsequently, the contact center server orchestrates a multimodal conversation in the multimodal communication session by speech-to-text conversion of customer messages received from the customer device, and text-to-speech conversion of agent messages received from the available chat agent with whom the multimodal communication session is established.

This application claims the benefit of U.S. Provisional Application Ser. No. 63/631,014 filed on Apr. 8, 2024, the contents of which are incorporated herein by reference in their entirety as if fully set forth below.

### FIELD

This technology generally relates to contact centers, and more particularly to methods, systems, and computer-readable media for providing multimodal conversation support at a contact center.

### BACKGROUND

Contact centers today cater to multiple geographies and customers speaking multiple languages. These contact centers encounter significant challenges when they do not have agents available to speak in the customer's preferred language. This language barrier not only hinders effective communication, but also impacts the overall customer experience. Without proficient agents who can understand and respond in the preferred language of the customer, there is a risk of miscommunication, frustration, and dissatisfaction. Moreover, this can limit the contact center's ability to cater to diverse customer demographics, potentially resulting in lost business opportunities and diminished brand loyalty.

Similarly, when customers prefer voice communication, but encounter a shortage of agents specialized in this mode, contact centers face a critical dilemma. Failure to meet customer preferences in communication mode can undermine the contact center's ability to provide personalized and efficient service, ultimately impacting its competitiveness in the market.

Existing technologies handle the lack of available voice agents by providing an option to the customer to switch the communication mode of the customer to chat. For example, when a customer is communicating with the contact center system via voice and a human agent capable of voice interaction is unavailable, the contact center system may send a short messaging service (SMS) message to the customer. When the customer clicks on a web link embedded in the SMS message, the contact center system initiates a chat interaction with a human agent. In this chat interaction, the customer sends messages to the human agent in text form, and the human agent responds to the customer in text form. The customer ends the voice interaction and starts the chat interaction with the human agent. Nevertheless, this process places an additional burden on the customer. Furthermore, the customer might not prefer interacting via chat or may be unable to engage in chat at that time.

Thus, addressing the challenges posed by language limitations and mode-specific expertise becomes imperative for contact centers striving to deliver exceptional customer experiences across diverse demographics and communication preferences.

### SUMMARY

In one example, the present disclosure relates to a method for multimodal conversation support at a contact center. The method implemented by a contact center server comprises providing as part of a voice conversation with a customer device, a first voice prompt to the customer device comprising: an indication of unavailability of any voice agent at any of a plurality of agent devices and an option to route the voice conversation to any available one of a plurality of chat agents at one of the plurality of agent devices. A confirmation from the customer device to route the voice conversation to any available one of the plurality of chat agents is received. In response to the received confirmation a multimodal communication session is established between the customer device and one of the available ones of the plurality of chat agents at the one of the plurality of agent devices. Further, a multimodal conversation is orchestrated in the multimodal communication session comprising speech-to-text conversion of one or more customer messages received from the customer device, and text-to-speech conversion of one or more agent messages received from the one of the available ones of the plurality of chat agents at the one of the plurality of agent devices.

In another example, the present disclosure relates to a contact center server comprising one or more processors and a memory. The memory coupled to the one or more processors which are configured to execute programmed instructions stored in the memory to provide as part of a voice conversation with a customer device, a first voice prompt to the customer device comprising: an indication of unavailability of any voice agent at any of a plurality of agent devices and an option to route the voice conversation to any available one of a plurality of chat agents at one of the plurality of agent devices. A confirmation from the customer device to route the voice conversation to any available one of the plurality of chat agents is received. In response to the received confirmation a multimodal communication session is established between the customer device and one of the available ones of the plurality of chat agents at the one of the plurality of agent devices. Further, a multimodal conversation is orchestrated in the multimodal communication session comprising speech-to-text conversion of one or more customer messages received from the customer device, and text-to-speech conversion of one or more agent messages received from the one of the available ones of the plurality of chat agents at the one of the plurality of agent devices.

In another example, the present disclosure relates to a non-transitory computer readable storage medium storing thereon instructions which when executed by one or more processors, causes the one or more processors to provide as part of a voice conversation with a customer device, a first voice prompt to the customer device comprising: an indication of unavailability of any voice agent at any of a plurality of agent devices and an option to route the voice conversation to any available one of a plurality of chat agents at one of the plurality of agent devices. A confirmation from the customer device to route the voice conversation to any available one of the plurality of chat agents is received. In response to the received confirmation a multimodal communication session is established between the customer device and one of the available ones of the plurality of chat agents at the one of the plurality of agent devices. Further, a multimodal conversation is orchestrated in the multimodal communication session comprising speech-to-text conversion of one or more customer messages received from the customer device, and text-to-speech conversion of one or more agent messages received from the one of the available ones of the plurality of chat agents at the one of the plurality of agent devices.

### BRIEF DESCRIPTION OF THE DRAWINGS

FIG. 1 is a block diagram of an exemplary contact center environment for implementing the concepts and technologies disclosed herein.

FIG. 2 is a flow chart of an exemplary method for orchestrating a multimodal customer conversation by a contact center server of FIG. 1.

FIG. 3 is an interaction diagram illustrating an exemplary multimodal conversation between a customer at the customer device and a chat agent at the agent device.

### DETAILED DESCRIPTION

Examples of the present disclosure relate to a contact center environment and, more particularly, to one or more components, systems, computer-readable media, and methods of the contact center environment. The contact center environment is configured to enable multimodal communication between customers who get in touch with the contact center for assistance and contact center agents, hereinafter referred to as “human agents.”

Customers engage with contact centers through various communication channels such as chat, voice, email or the like. Customer voice interactions begin, for example, when the customer places a call to a contact number associated with the contact center's interactive voice response (IVR) or artificial intelligence (AI) service, although the voice interactions may begin using other types and/or numbers of methods. The IVR service may employ a fixed menu structure, where the customer navigates through pre-defined options by pressing corresponding keys on the customer device. Alternatively, the IVR service may incorporate natural language processing capabilities, allowing the customer to interact with the system using spoken language. The customer can articulate their requests or issues in natural language, and the IVR service interprets these inputs to provide appropriate responses, actions, or directing the customer to a human agent within the contact center. The AI service may be a virtual assistant operating in voice mode. Upon connection, the virtual assistant automatically engages with the customer device, utilizing advanced natural language processing (NLP) algorithms to understand and interpret the customer inputs. The virtual assistant dynamically processes the customer's queries or issues in real time, providing relevant responses, actions, or directing the customer to a human agent within the contact center.

The IVR service or AI service may route the customer voice interaction to one of the human agents at an agent device of the contact center, such as a voice agent or a chat agent by way of example. In one example, when no appropriate human agents are available to handle incoming customer interactions, the voice interaction may be placed in a queue. Once a suitable human agent becomes available, the voice interaction is routed to the human agent for handling.

Contact centers manage a wide range of communication channels, including voice calls, live chat, emails, and social media messages. Contact centers may manage the incoming interactions from these communication channels using call queuing. Call queuing is a system used to manage incoming communications from customers when all available agents are busy. Instead of losing the call or forcing the customer to call back later, the system places the customer in a virtual “queue.” The queue holds the customer's place in line and connects the customer to an available agent as soon as one becomes free to handle an incoming interaction.

The contact center administrators may configure multiple queues based on skills of the human agents, communication modes of the agents, or the like. In one example, a queue may be configured based on a skill such as the language of communication of the human agents. In another example, a queue may be configured based on communication modes of the human agents such as voice, chat, or the like.

Subsequent to the IVR service or an AI service determining that the customer voice interaction should be routed to a human agent, the contact center server places the voice interaction in a voice queue to speak with a human agent who communicates in voice mode i.e. a voice agent. In one example, the contact center server 150 may manage one queue for voice and chat interactions. According to the aspects of the present disclosure, if the voice agents are not available or if the waiting time to connect with a voice agent is high, the contact center system may offer the customer an option to interact with a human agent who communicates in a different communication mode such as chat i.e. chat agent. If the customer agrees to interact with a chat agent, the contact center system places the voice interaction in a chat queue, checks for available chat agents. When a chat agent is available, the contact center system establishes a multimodal communication session between the customer device and the available chat agent device. Subsequently, the customer continues to interact in the voice mode. The contact center system acts as a multimodal conversation orchestrator by converting the voice messages from the customer to text and transmitting the text to the chat agent; and converting the text messages from the chat agent to speech and providing the audio of the speech to the customer. This ensures a more efficient and satisfactory user experience by reducing wait times and providing flexibility in communication options.

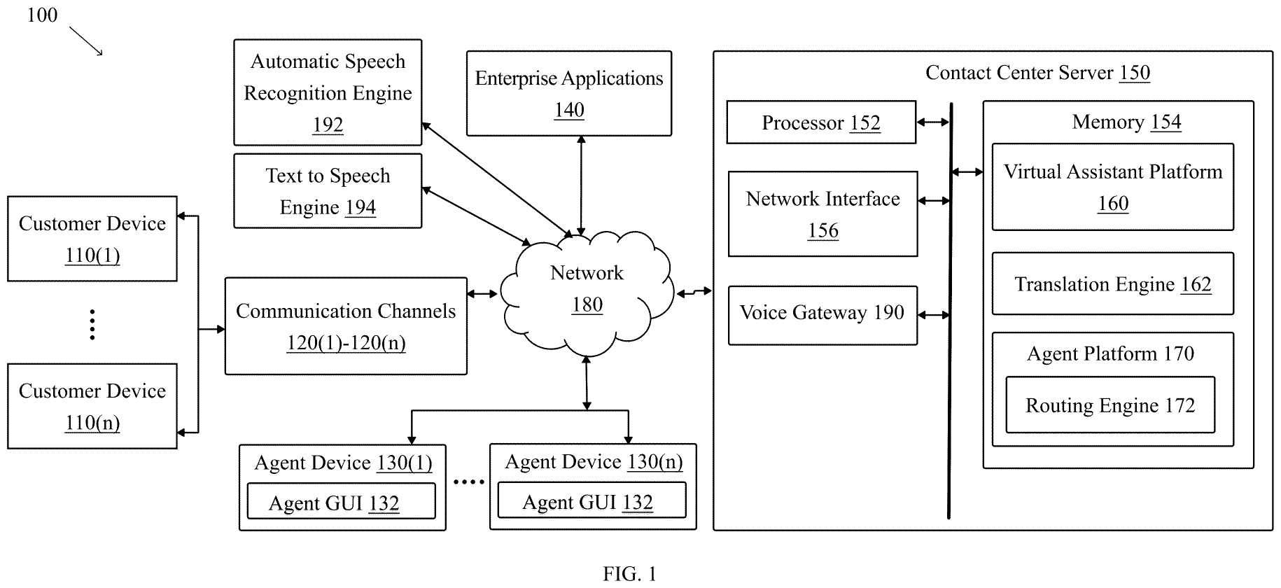

FIG. 1 is a block diagram of an exemplary contact center environment 100 for implementing the concepts and technologies disclosed herein. The contact center environment 100 includes: a plurality of customer devices 110(1)-110(n), a plurality of communication channels 120(1)-120(n), a plurality of agent devices 130(1)-130(n), enterprise applications 140, an Automatic Speech Recognition (ASR) engine 192, a Text-to-Speech (TTS) engine 194, a contact center server 150 coupled together via a network 180, although the contact center environment 100 can include other types and/or numbers of systems, devices, components, and/or elements in other examples. While the ASR engine 192 and the TTS engine 194 are depicted as separate components from the contact center server 150 in FIG. 1, it may be understood that, in one example, the ASR engine 192 and the TTS engine 194 may be integrated within the contact center server 150. While not shown, the exemplary contact center environment 100 may include additional network components, such as gateways, routers, switches and other devices, which are well known to those of ordinary skill in the art and thus will not be described here.

Referring to FIG. 1, the contact center server 150 manages incoming voice communication sessions and multimodal communication sessions. The contact center server 150 may use automation and artificial intelligence, human agents, or a combination of these to resolve issues of customers in the voice communication sessions and the multimodal communication sessions. In one example, the voice communication session may be directly assigned to a human agent. In another example, the voice communication session may be initially handled by an interactive voice response (IVR) server or a virtual assistant and then routed to the human agent at a later point in the conversation when the customer requests the transfer or when the intervention of the human agent is required. In another example, the human agent may handle the conversation with the customer during the voice communication session and the virtual assistant may provide suggestions to the human agent to handle the conversation.

The contact center server 150 includes a processor 152, a memory 154, a network interface 156 and a voice gateway 190, although the contact center server 150 may include other types and/or numbers of components in other examples. In addition, the contact center server 150 may include an operating system (not shown). In one example, the contact center server 150 and/or processes performed by the contact center server 150 may be implemented using a networking environment (e.g., cloud computing environment) or offered as a service by the cloud computing environment.

The components of the contact center server 150 may be coupled by a graphics bus, a memory bus, an Industry Standard Architecture (ISA) bus, an Extended Industry Standard Architecture (EISA) bus, a Micro Channel Architecture (MCA) bus, a Video Electronics Standards Association (VESA) Local bus, a Peripheral Component Interconnect (PCI) bus, a PCI-Express (PCIe) bus, a serial advanced technology attachment (SATA) bus, a Personal Computer Memory Card Industry Association (PCMCIA) bus, an Small Computer Systems Interface (SCSI) bus, or a combination of two or more of these, although the components of the contact center server 150 may be coupled using other types and/or numbers of buses or systems in other examples. In one example, the components of the contact center server 150 may be communicatively coupled with each other.

The processor(s) 152 of the contact center server 150 may execute one or more computer-executable instructions stored in memory 154 for the methods illustrated and described with reference to the examples herein, although the processor can execute other types and numbers of instructions and perform other types and numbers of operations. The processor(s) 152 may comprise one or more central processing units (CPUs), or general-purpose processors with a plurality of processing cores, such as Intel® processor(s), AMD® processor(s), although other types of processor(s) could be used in other configurations.

The memory 154 of the contact center server 150 is an example of a non-transitory computer readable storage medium capable of storing information or instructions for the processor 152 to operate on. The instructions, which when executed by the processor 152, perform one or more of the disclosed examples. In one example, the memory 154 may be a random access memory (RAM), a dynamic random access memory (DRAM), a static random access memory (SRAM), a persistent memory (PMEM), a nonvolatile dual in-line memory module (NVDIMM), a hard disk drive (HDD), a read only memory (ROM), an erasable programmable read-only memory (EPROM), an electrically erasable programmable read-only memory (EEPROM), a programmable ROM (PROM), a flash memory, a compact disc (CD), a digital video disc (DVD), a magnetic disk, a universal serial bus (USB) memory card, a memory stick, or a combination of two or more of these. It may be understood that the memory 154 may include other electronic, magnetic, optical, electromagnetic, infrared or semiconductor based non-transitory computer readable storage medium which may be used to tangibly store instructions, which when executed by the processor 152, perform the disclosed examples. The non-transitory computer readable medium is not a transitory signal per se and is any tangible medium that contains and stores the instructions for use by or in connection with an instruction execution system, apparatus, or device. Examples of the programmed instructions and steps stored in the memory 154 are illustrated and described by way of the description and examples herein.

As illustrated in FIG. 1, the memory 154 may include instructions corresponding to a virtual assistant platform 160, a translation engine 162, and an agent platform 170 of the contact center server 150, although other types and/or numbers of instructions in the form of programs, functions, methods, procedures, definitions, subroutines, or modules may be stored. One or more components of the memory 154 may be communicatively coupled with each other. The memory 154 stores various types of data including instructions, program code, and data structures necessary for the operation of the virtual assistant platform 160, the translation engine 162, and the agent platform 170. The contact center server 150 receives communication from the one or more customer devices 110(1)-110(n) and provides a response to the communication.

An enterprise user such as a developer or a business analyst may create or configure a virtual assistant using the virtual assistant platform 160. In one example, when the customer at the customer device 110(1) communicates with the contact center server 150, the virtual assistant platform 160 may provide a response to the customer communication. The contact center server 150 may communicate with the virtual assistant platform 160, the translation engine 162, the agent platform 170, the plurality of agent devices 130(1)-130(n), the enterprise applications 140, or one or more other components of the contact center environment 100 to provide the response to the customer, although the contact center server 150 may provide the response by communicating with other types and/or numbers of devices in other examples. The virtual assistant platform 160 may host a plurality of virtual assistants (not shown) deployed by one or more enterprises. The memory 154 may also include a natural language processing (NLP) engine (not shown), and a conversation orchestration engine (not shown), although the memory 154 may include other types and/or numbers of components in other configurations.

The agent platform 170 of the contact center server 150 facilitates communication between the contact center server 150 and the one or more agent devices 130(1)-130(n). The agent platform 170 includes a routing engine 172 which handles routing the communication to one of the plurality of agent devices 130(1)-130(n), although the agent platform 170 may include other types and/or numbers of components in other configurations. In one example, the agent platform 170 manages routing communication received by and/or managed by the contact center server 150 to one of the plurality of agent devices 130(1)-130(n).

The contact center server 150 also acts as a communication intermediary between the plurality of customer devices 110(1)-110(n) and the plurality of agent devices 130(1)-130(n). For example, messages from the customer device 110(1) may be output to the agent device 130(n) via the contact center server 150. The routing engine 172 may be configured using routing models or rules to route customer conversations to human agents, although the routing engine 172 may use other types and/or numbers of methods or technologies to connect the customers with the human agents or virtual assistants or virtual agents. In one example, the routing models may be artificial intelligence powered routing models that leverage machine learning algorithms to make intelligent decisions about how to route customer conversations. In another example, the routing engine 172 utilizes static or dynamic rule-based routing strategies. The routing engine 172 may use agent skills, agent queues, conversation type, or the like to route customer conversations to the one or more agent devices 130(1)-130(n).

The routing engine 172 routes a customer conversation that requires human agent intervention to an available human agent at one of the plurality of agent devices 130(1)-130(n) based on, for example: (1) path navigated by the customer in an IVR menu, (2) current emotion state of the customer (e.g., angry, frustrated, cool, neutral, etc.), (3) behavioral history information of the customer collected and saved each time when the customer previously contacted the contact center (e.g., call/chat abandonments, prefers to talk to a human agent, etc.), (4) feedback ratings given by the customer for the services received during previous contact center interactions, (5) account type of the customer (e.g., platinum, gold, silver, etc.), (6) customer waiting time in the queue, (7) availability of the one or more voice agents or chat agents, or the like (8) skill set and level of the available human agents, (9) average waiting time in the human agent queue, (10) customer requesting to talk to a human agent, (11) language preferences of the customer, (12) language capabilities of the human agents, (13) mode of the customer conversation such as voice, chat, email, although the routing may be performed based on other types and/or numbers of parameters or information in other examples. In one example, the routing engine 172 may retrieve data regarding skill set and level of the human agents at one or more of the agent devices 130(1)-130(n) stored in a database of the contact center server 150. The retrieved data may be used in routing the customer conversation to one of the available human agents. In another example, if no human agent at one of the agent devices 130(1)-130(n) is available to handle the customer conversation in voice mode as a voice agent, then the routing engine 172 may place the customer conversation in a chat agent queue until one of the human agents at one of the agent devices 130(1)-130(n) is available to handle the conversation as a chat agent. The routing engine 172 comprises a programming module or one or more routing algorithms executed by the processor 152 to perform the routing functions based on the one or more factors disclosed above.

The contact center server 150 hosts and/or manages the translation engine 162 in the memory 154. In one example, the translation engine 162 may be hosted external to the contact center server 150 by one or more third-party servers. The translation engine 162 facilitates real-time or near-real-time communication between the human agents and customers who speak different languages. The translation engine 162 may leverage advanced natural language processing (NLP) algorithms and machine learning models to automatically detect the language spoken by the customer. Once detected, the translation engine 162 dynamically translates the customer's inputs into the preferred language of the human agent or vice versa.

In one example, the translation engine 162 may comprise one or more language models such as large language models (LLM's). The contact center server 150 enables integration with the LLM's, for example, in a bring-your-own (BYO) model framework. The LLM's may comprise, for example, Kore.ai XO GPT, XO GPT-3, XO GPT-4, Claude 3, or LLaMA, although there may be other types and/or number of LLM's in other configurations. It may be understood that the contact center server 150 may integrate with other types and/or numbers of models such as small language models or other machine learning models in other examples. The LLM's are large language models which may perform tasks such as data generation, text generation, text summarization, response rephrasing, language translation, although other types of models configured for other types and/or numbers of tasks or operations may be used.

The contact center server 150 provides the LLM's with inputs, such as prompts by way of example. Based on the inputs, the LLM's rephrases a textual response, translates the textual response from one language to another, although the LLM's may perform other types and/or numbers of tasks in other examples.

The voice gateway 190 enables communications in voice mode with the contact center server 150. The voice gateway 190 handles incoming voice calls from the plurality of customer devices 110(1)-110(n), and responds to these voice calls based on a voice program aligned with the communication routing setup of the contact center server 150. The voice program may be a script in a scripting language such as voice extensible markup language (VXML). The voice gateway 190 interacts with the components of the contact center server 150, the plurality of customer devices 110(1)-110(n), the ASR engine 192, and the TTS engine 194 to drive customer conversations. The voice gateway 190 may comprise a SIP orchestrator (not shown) and a media manager (not shown), although there may be other types and/or numbers of components in other examples. The SIP orchestrator orchestrates communication with various components and the media manager manages all the media for the voice gateway 190 and orchestrates with the ASR engine 192 and the TTS engine 194. The voice gateway 190 may also support standards and/or formats such as, for example, voiceXML, Call Control extensible Markup Language (CCXML), or Speech Application Language Tags (SALT), although other types and/or numbers of formats may be supported by the voice gateway 190 in other examples.

The network interface 156 may include hardware, software, or a combination of hardware and software, enabling the contact center server 150 to communicate with the components illustrated in the contact center environment 100, although the network interface 156 may enable communication with other types and/or number of components in other configurations. In one example, the network interface 156 provides interfaces between the contact center server 150 and the network 180. The network interface 156 may support wired or wireless communication. In one example, the network interface 156 may include an Ethernet adapter or a wireless network adapter to communicate with the network 180.

The plurality of customer devices 110(1)-110(n) may communicate with the contact center server 150 via the network 180. The customers at the plurality of customer devices 110(1)-110(n) may access and interact with the functionalities exposed by the contact center server 150. The plurality of customer devices 110(1)-110(n) can include any type of computing device that can facilitate customer interaction, for example, a desktop computer, a laptop computer, a tablet computer, a smartphone, a mobile phone, a wearable computing device, or any other type of device with communication and data exchange capabilities. The plurality of customer devices 110(1)-110(n) may include software and hardware capable of communicating with the contact center server 150 via the network 180. Also, the plurality of customer devices 110(1)-110(n) may render and display the information received from the contact center server 150. The plurality of customer devices 110(1)-110(n) may render an interface of any of the plurality of communication channels 120(1)-120(n) which the customers may use to communicate with the contact center server 150. The plurality of customer devices 110(1)-110(n) and the contact center server 150 may communicate via one or more application programming interfaces (APIs) or one or more hyperlinks exposed by the contact center server 150.

The customers at the plurality of customer devices 110(1)-110(n) may communicate with the contact center server 150 by providing text input or voice input via any of the plurality of communication channels 120(1)-120(n). The plurality of communication channels 120(1)-120(n) may include channels such as, for example, enterprise messengers (e.g., Skype for Business, Microsoft Teams, Kore.ai Messenger, Slack, Google Hangouts, or the like), social messengers (e.g., Facebook Messenger, WhatsApp Business Messaging, Twitter, Lines, Telegram, or the like), web & mobile (e.g., a web application, a mobile application), interactive voice response (IVR), voice calls (e.g., made using mobile networks), voice channels (e.g., Google Assistant, Amazon Alexa, or the like), live chat channels (e.g., LivePerson, LiveChat, Zendesk Chat, Zoho Desk, or the like), a webhook, a short messaging service (SMS), email, a software-as-a-service (SaaS) application, voice over internet protocol (VoIP) calls, computer telephony calls, or the like. The customers may communicate with the contact center server 150 via any of the plurality of communication channels 120(1)-120(n) using any of the plurality of customer devices 110(1)-110(n) via the network 180. It may be understood that to enable text or voice-based communication, the contact center environment 100 may include components such as, for example, Interactive Voice Response (IVR) systems, Session Border Controllers (SBC's), Session Initiation Protocol (SIP) servers, firewalls that are not illustrated in FIG. 1.

The human agents may operate the plurality of agent devices 130(1)-130(n) to interact with the contact center server 150, the enterprise applications 140, or the plurality of customer devices 110(1)-110(n) via the network 180. The plurality of agent devices 130(1)-130(n) may be communication devices such as a desktop computer, a laptop, a smart phone, a tablet, a wearable device, or a tablet, although there may be other types and/or numbers of devices in other examples. The plurality of agent devices 130(1)-130(n) include one or more processors, one or more memories, one or more input devices such as a keyboard, a mouse, a display device, a touch interface, and/or one or more communication interfaces, which may be coupled together by a bus or other communication link, although each may have other types and/or numbers of other systems, devices, components, and/or other elements. The plurality of agent devices 130(1)-130(n) may be configured to interact with one or more components of the contact center environment 100 in voice, chat, email, or other communication modes, enabling the methods and functionalities described herein.

The plurality of agent devices 130(1)-130(n) comprise an agent graphical user interface (GUI) 132 that may render, and display data received from the contact center server 150 or the plurality of customer devices 110(1)-110(n). The plurality of agent devices 130(1)-130(n) may run applications such as web browsers or contact center software, which may render the agent GUI 132, although other applications may render the agent GUI 132. The human agents at the plurality of agent devices 130(1)-130(n) may be: voice agents capable of communicating with customers in voice mode or chat agents capable of communicating with customers in chat mode, although the plurality of agent devices 130(1)-130(n) may handle customer conversations in email mode or other types and/or a combination of communication modes. The plurality of agent devices 130(1)-130(n) may access the enterprise applications 140 via one or more application programming interfaces (APIs) or one or more uniform resource locators (URLs), although the one or more agent devices 130(1)-130(n) may access other types and/or numbers of applications in other configurations.

The plurality of customer devices 110(1)-110(n) or the plurality of agent devices 130(1)-130(n) may be communication devices, such as a desktop computer, a laptop, a smart phone, a tablet, a wearable device, a laptop, or a tablet, although there may be other types and/or numbers of devices in other examples. The plurality of customer devices 110(1)-110(n) include one or more processors, one or more memories, one or more input devices such as a keyboard, a mouse, a display device, a touch interface, and/or one or more communication interfaces, which may be coupled together by a bus or other communication link, although each may have other types and/or numbers of other systems, devices, components, and/or other elements. The plurality of customer devices 110(1)-110(n) may be configured to interact with one or more components of the contact center environment 100 via the plurality of communication channels 120(1)-120(n) in voice, chat, email, or other communication modes, enabling the methods and functionalities described herein.

The network 180 may enable communication between one or more components of the contact center environment 100. The network 180 may be, for example, an ad hoc network, an extranet, an intranet, a wide area network (WAN), a virtual private network (VPN), a local area network (LAN), a wireless LAN (WLAN), a wireless WAN (WWAN), a metropolitan area network (MAN), internet, a portion of the internet, a portion of the public switched telephone network (PSTN), a cellular telephone network, a wireless network, a Wi-Fi network, a worldwide interoperability for microwave access (WiMAX) network, or a combination of two or more of these networks, although the network 180 may include other types and/or numbers of networks in other topologies or configurations.

The network 180 may support protocols such as Session Initiation Protocol (SIP), Hypertext Transfer Protocol (HTTP), Hypertext Transfer Protocol Secure (HTTPS), Media Resource Control Protocol (MRCP), Real Time Transport Protocol (RTP), Real-Time Streaming Protocol (RTSP), Real-Time Transport Control Protocol (RTCP), Session Initiation Protocol (SIP), Session Description Protocol (SDP), Web Real-Time Communication (WebRTC), Transmission Control Protocol/Internet Protocol (TCP/IP), User Datagram Protocol (UDP), or Voice over Internet Protocol (VoIP), although other types and/or numbers of protocols may be supported in other topologies or configurations. The network 180 may also support standards and/or formats such as, for example, hypertext markup language (HTML), extensible markup language (XML), voiceXML, call control extensible markup language (CCXML), JavaScript object notation (JSON), although other types and/or numbers of data, media, and document standards and formats may be supported in other topologies or configurations. The network interface 156 of the contact center server 150 may include any interface that is suitable to connect with any of the above-mentioned network types and communicate using any of the above-mentioned network protocols in any of the above-mentioned standards and/or formats.

The enterprise applications 140 may comprise applications such as customer relationship management (CRM) applications, document management and collaboration applications, human resources management (HRM), enterprise resource planning (ERP) systems, analytics and reporting systems, productivity systems, project management systems, sales applications, enterprise data lakes, although there may be other types and/or numbers of enterprise applications 140 in other examples. The enterprise applications 140 may store information related to customers including profile details (e.g., name, address, phone numbers, sex, age, occupation, etc.), communication channel preference (e.g. text chat, SMS, voice chat, multimedia chat, social networking chat, web, telephone call, etc.), language preference, membership information (e.g., membership ID, membership category), and transaction data (e.g., voice communication session or multimodal communication session details such as: date, time, call handle time, issue type, call audio data, transcripts, or the like). Further, the enterprise applications 140 may also store other information of previous customer interactions such as: sentiment, emotional state, call deflection, feedback and ratings, or the like.

The enterprise applications 140 may be updated dynamically or periodically based on the customer conversations with the contact center or the human agents at the plurality of agent devices 130(1)-130(n). In one example, the CRM database may be updated with customer interaction information such as, for example, attributes of the customer who called (e.g., customer name, address, phone number, email), attributes of the human agent who took the call (e.g., agent name, agent identifier), call time, call date, total call handle time, call issue type handled, conversation transcript, customer emotion states, or customer feedback, to the enterprise applications 140 for future reference, although other types and/or numbers of information may be updated to the enterprise applications 140. In one example, the customer data, the interaction data between the customers, the contact center server 150, and the plurality of the agent devices 130(1)-130(n) may be stored at a memory 154 or a data storage (not shown) of the contact center server 150.

The Automatic Speech Recognition (ASR) engine 192 may perform speech recognition on the incoming audio of the voice communication session or multimodal communication session from the customer device 110(1). The ASR engine 192 may receive the incoming audio from the contact center server 150, although the ASR engine 192 may receive the incoming audio from other components of the contact center environment 100 or other types and/or numbers of components in other examples. The ASR engine 192 converts spoken language into text or commands, enabling users to interact with devices or applications of the contact center environment 100, although the ASR engine 192 may perform other types and/or numbers of functions in other examples.

The Text to Speech (TTS) engine 194 may synthesize the textual response from the agent device 130(1) into audio. The TTS engine 194 synthesizes text into spoken audio, allowing devices or applications to verbally communicate information to the plurality of customer devices 110(1)-110(n). The TTS engine 194 processes text input, generates speech output, and plays back the synthesized audio in real-time, although the TTS engine 194 may perform other types and/or numbers of functions in other examples. The TTS engine 194 may provide the synthesized audio to the contact center server 150, although the TTS engine 194 may provide the synthesized audio to other components of the contact center environment 100 or other types and/or numbers of components in other examples.

Further, in view of FIG. 1, once the customer conversation that is part of the voice communication session is routed to the human agent operating one of the one or more agent devices 130(1)-130(n), the contact center server 150 may provide the conversation transcript of the conversation to the human agent, so that the human agent can read-through the transcript to understand the intent of the customer. The contact center server 150 may translate the messages of the customer from a first language to a second language used by the human agent. In one example, the contact center server 150 may translate customer messages from Spanish to English and then present the translated message to the agent device 130(1). Similarly, contact center server 150 can translate messages from the agent device 130(1) in English to Spanish and then deliver the translated message to the customer device 110(1).

The virtual assistant platform 160 of the contact center server 150 may assist the human agent by suggesting one or more responses and/or actions to a customer message. In another example, the virtual assistant platform 160 may assist the human agent by providing one or more intents, one or more entities, or one or more entity values corresponding to the one or more entities that are identified from the customer message.

An intent may in this example be defined as a purpose of the customer. The intent of the customer may be determined from a message provided by the customer and fulfilled by the contact center using one or more virtual assistants, one or more human agents, or a combination of one or more virtual assistants and one or more human agents. Example intents include: book flight, book train, book cab, book movie ticket, restaurant search, ecommerce search, check balance, document search, or the like. To fulfill the intent, the virtual assistant platform 160 may need one or more entities defined by entity parameters including: an entity name, an entity type, an entity value, or the like, although there may be other types and/or numbers of entity parameters in other configurations. In an example, entity types may include: airport, address, city, company name, color, currency, product category, date, time, location, place name, etc. For example, in an utterance “Book flight tickets from San Diego to New York”, the intent of the customer is “book flight”. “San Diego” and “New York” are the entity values whose entity type is “city”.

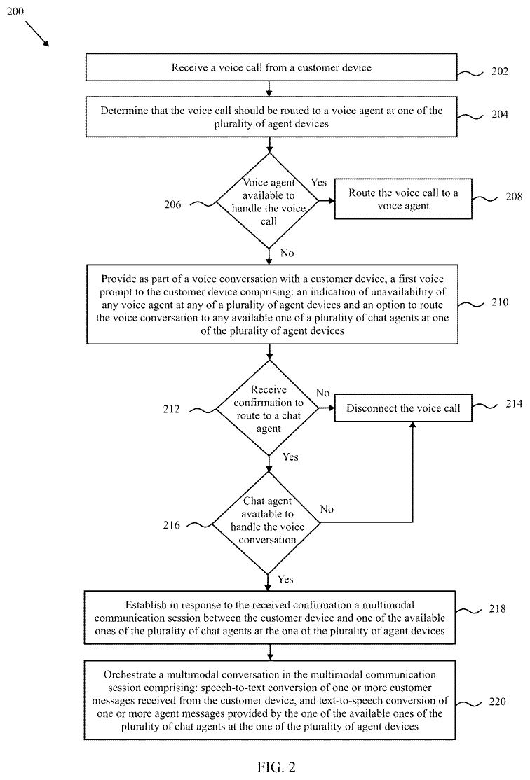

FIG. 2 is a flowchart of an exemplary method 200 for orchestrating a multimodal conversation by the contact center server 150 between the customer at the customer device 110(1) and the human agent at the agent device 130(1). Initially, the customer may initiate a voice communication session with the contact center server 150 by, for example, calling a contact number associated with: a virtual assistant or an IVR service hosted and/or managed by the contact center server 150. At step 202, in this example the contact center server 150 receives the voice call from the customer device 110(1) and initiates a voice conversation. Subsequently, at step 204, the contact center server 150 may determine that the voice call should be routed to a voice agent at one of the plurality of agent devices 130(1)-130(n), for example, based on, a request by the customer to talk to a voice agent, an escalation by the customer, or a sentiment of the voice call, although the routing to a voice agent may be determined using other types and/or numbers of parameters in other examples.

In one example, the customer at the customer device 110(1) conversing with a virtual assistant (not shown) may send a voice message to route the conversation to any available voice agent at the plurality of agent devices 130(1)-130(n). The request to route to a voice agent may comprise, by way of example, a voice message—“I want to talk to an agent,” although the customer may provide other types and/or numbers of voice messages to route to an agent. In another example, the customer at the customer device 110(1) may be conversing with an IVR server (not shown) of the contact center server 150 and requests to route to any human agent (i.e. voice or chat agent) available at the plurality of agent devices 130(1)-130(n). In another example, the contact center server 150 may determine that a human agent intervention is required to manage the customer conversation and routes the conversation to a human agent.

Before transferring the voice call to a voice agent at one of the plurality of agent devices 130(1)-130(n), the contact center server 150 may place the caller in a queue based on various factors, such as agent skill, communication mode (e.g., voice, chat, email), or other relevant criteria. In one example, when a voice call is received and it is determined that the call should be routed to a voice agent at one of the plurality of agent devices 130(1)-130(n), the contact center server 150 places the customer call in a voice agent queue. Subsequently, at step 206, the contact center server 150 monitors, in real-time, the availability status of voice agents at the plurality of agent devices 130(1)-130(n) to handle the voice call. If a voice agent is available at one of the plurality of agent devices 130(1)-130(n), then at step 208, the contact center server 150 routes the voice call to the voice agent available at the one of the plurality of agent devices 130(1)-130(n).

In this example, the contact center server 150 upon monitoring determines that no voice agent at one of the plurality of agent devices 130(1)-130(n) is available to interact with the customer. For example, when the contact center server 150 encounters a surge in voice calls, all voice agents at the plurality of agent devices 130(1)-130(n) may be assigned to manage these voice calls, resulting in no available voice agents for other voice calls.

At step 210, the contact center server 150 in this example provides as part of the voice conversation with the customer device 110(1), a first voice prompt to the customer device 110(1). The first voice prompt comprises: an indication of unavailability of any voice agent at any of the plurality of agent devices 130(1)-130(n). Further, the voice prompt includes an option to route the voice conversation to any available one of a plurality of chat agents at one of the plurality of agent devices 130(1)-130(n). In one example, the voice prompt may be—“Voice agents are not available to handle your call at this moment. Would you like to join a voice conversation with a chat agent. The conversation will continue as a voice call.” In another example, the voice prompt may be—“Voice agents are not available to handle your call at this moment. Would you like to join a voice conversation with a chat agent. Press 1 to confirm.” The customer at the customer device 110(1) may listen to the first voice prompt.

At step 212, the contact center server 150 determines if a confirmation is received from the customer device 110(1) to route the voice conversation to any available one of the plurality of chat agents at one of the agent devices 130(1)-130(n). In this example, the contact center server 150 receives a confirmation from the customer device 110(1) to route the voice conversation to any available one of the plurality of chat agents at one of the agent devices 130(1)-130(n). By way of example, the customer at the customer device 110(1) may provide the confirmation by: saying “yes,” or “please connect,” pressing a key 1 at the customer device 110(1), using a software application such as, for example, a web based or a desktop application at the customer device 110(1), although the customer may provide other types of confirmation in other examples. At step 214, if the contact center server 150 does not receive the confirmation, the contact center server 150 may disconnect the voice call with the customer device 110(1). In one example, prior to the disconnecting, the contact center server 150 may inform the customer at the customer device 110(1) that there are no voice agents available and the call will be disconnected.

Upon receiving the confirmation, the contact center server 150 places the voice conversation of the customer in a chat queue. Subsequently, at step 216, the contact center server 150 monitors the availability status of chat agents in real-time to handle the voice conversation with the customer device 110(1). If a chat agent at one of the plurality of agent devices 130(1)-130(n) is not available, then the contact center server 150 may disconnect the voice conversation with the customer device 110(1). In one example, prior to the disconnecting, the contact center server 150 may inform the customer at the customer device 110(1) that there are no chat agents at one of the agent devices 130(1)-130(n) available and the call will be disconnected.

If one or more chat agents at the plurality of agent devices 130(1)-130(n) are available to handle the voice conversation with the customer device 110(1), at step 218, the contact center server 150 establishes in response to the received confirmation a multimodal communication session between the customer device 110(1) and one of the available ones of the plurality of chat agents at the one of the plurality of agent devices 130(1)-130(n), for example, the agent device 130(1). The multimodal communication session comprises voice communication with the customer device 110(1) and chat communication with the agent device 130(1). In one example, the contact center server 150 may establish the multimodal communication session between the customer device 110(1) and the agent device 130(1) by connecting the agent device 130(1) to the existing voice communication session with the customer device 110(1). Subsequently, the contact center server 150 may provide a voice prompt to the customer device 110(1) that the chat agent is connected to assist the customer.

At step 220, the contact center server 150 orchestrates a multimodal conversation in the multimodal communication session comprising: speech-to-text conversion of one or more customer messages received from the customer device, and text-to-speech conversion of one or more agent messages provided by the one of the available ones of the plurality of chat agents at the one of the plurality of agent devices, for example, the agent device 130(1).

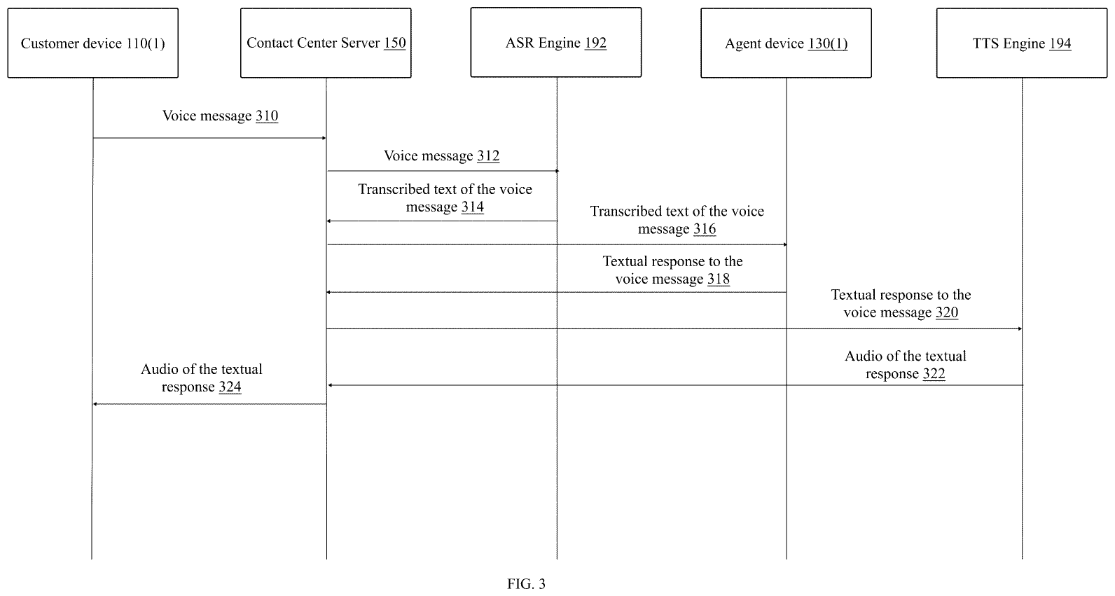

FIG. 3 is an interaction diagram illustrating an exemplary multimodal conversation between a customer at the customer device 110(1) and a chat agent at the agent device 130(1) orchestrated by the contact center server 150 during the multimodal communication session. At step 310, the voice gateway 190 of the contact center server 150 receives a voice message from the customer device 110(1).

At step 312, the voice gateway of the contact center server 150 provides the voice message to an ASR engine 192. The ASR engine 192 transcribes the voice message and generates a text of the voice message. At step 314, the contact center server 150 receives the transcribed text of the voice message from the ASR engine 192.

At step 316, the contact center server 150 transmits the transcribed text of the voice message to the chat agent at the agent device 130(1). The contact center server 150 may send the transcript of the voice conversation to the agent device 130(1). The contact center server 150, in this example, may also provide the voice message to the agent device 130(1).

At step 318, the chat agent at the agent device 130(1) provides, to the contact center server 150, a textual response to the voice message. The agent device 130(1) may also provide synthesis information, such as the tone in which the voice should be synthesized for the textual response. In one example, the agent at the agent device 130(1) may provide a selection of the tone as “empathetic,” “firm,” “calm,” or the like. The contact center server 150 receives the textual response from the agent device 130(1). Further, the contact center server 150 may additionally receive the synthesis information from the agent device 130(1) and provide the synthesis information to the TTS engine 194. The contact center server 150 may automatically determine the synthesis information based on an analysis of a transcript of the communication session. In one example, based on analysis of the transcript of the communication session, the contact center server 150 may determine that the sentiment of the conversation is negative. Based on this analysis, the contact center server 150 may provide synthesis information as “empathetic” or “calm” to instruct the TTS engine 194 to synthesize an empathetic or a calm audio.

At step 320, the voice gateway 190 of the contact center server 150 transmits the textual response to the voice message to the TTS engine 194. The TTS engine 194 converts the textual response to the voice message to audio. In one example, the TTS engine 194 may synthesize the audio based on the synthesis information provided by the contact center server 150. At step 322, the TTS engine 194 transmits the audio of the textual response to the voice gateway 190 of the contact center server 150. At step 324, the voice gateway 190 of the contact center server 150 provides the audio of the textual response to the customer device 110(1).

The contact center server 150 may use the translation engine 162, other language models or translation services to translate customer messages or agent responses from one language to another, although the contact center server 150 may use other types and/or numbers of models for language translation in other examples.

By way of a particular example, the voice message from the customer device 110(1) may be in Spanish. If the chat agent at the agent device 130(1) communicates only in English, the contact center server 150 additionally translates customer's voice message in Spanish to a textual message in English and provides the textual message in English to the agent device 130(1). The contact center server 150 may, subsequent to step 314, translate the textual message in Spanish to a textual message in English. Similarly, the contact center server 150, subsequent to step 318, translates chat agent's textual message in English to a voice message in Spanish and provides the voice message in Spanish to the customer device 110(1). The contact center server 150 may communicate with the translation engine 162, one or more third-party translation engines, the ASR engine 192, and the TTS engine 194 to perform the above-mentioned translation.

Further illustrating the orchestration of FIG. 2 and FIG. 3, the contact center server 150 may implement a state signaling protocol to orchestrate the multimodal communication session between, for example, the customer device 110(1) and the agent device 130(1). The multimodal communication session may be a duplex communication session, although there may be other types and/or numbers of multimodal communication sessions in other examples. The state signaling protocol may comprise three communication states: agent response, audio play (i.e. playing audio of the textual response to the customer), or customer message, although there may be other types and/or numbers of communication states in other examples. The contact center server 150 may use state indicators to tag the voice conversation or the multimodal communication session with the communication states. The contact center server 150 may manage the state of each multimodal communication session between the plurality of customer devices 110(1)-110(n) and the plurality of agent devices 130(1)-130(n) using the communication states.

In one example, the contact center server 150 updates the state indicator of the multimodal communication session between the customer at the customer device 110(1) and the human agent at, for example, the agent device 130(1) to the customer message state, at step 310 of FIG. 3, when the contact center server 150 receives the voice message from the customer device 110(1). In another example, the contact center server 150 may determine that the customer is talking or providing a voice message based on an input from the ASR engine 192 and updates the state indicator of the multimodal communication session to customer message state. In the customer message state, the contact center server 150 orchestrates the multimodal communication session based on the rules corresponding to the customer message state. In one example rule, at step 310, when the communication state is in the customer message state, the contact center server 150 provides instructions to the agent device 130(1) based on which the agent device 130(1) renders an indication in the agent GUI 132 of the agent device 130(1) that the customer is talking or providing a voice message.

The contact center server 150 updates the state indicator of the multimodal communication session between the customer at the customer device 110(1) and the human agent at, for example, the agent device 130(1) to the agent response state, after step 316 and before step 318 of FIG. 3, when the human agent at the agent device 130(1) starts typing. In another example, the contact center server 150 updates the state indicator of the multimodal communication session between the customer at the customer device 110(1) and the human agent at the agent device 130(1) to the agent response state, after step 316 and before step 318 of FIG. 3, when the agent device 130(1) is playing the voice message from the customer device 110(1).

In the agent response state, the contact center server 150 orchestrates the multimodal communication session based on the rules corresponding to the agent response state. In one example rule, the contact center server 150 may allow the human agent at the agent device 130(1) to provide only a single response to the voice message. In another example rule, the contact center server 150 may allow the human agent at the agent device 130(1) to provide multiple responses to the voice message.

The agent response state may be interrupted when the contact center server 150 receives another voice message from the customer at the customer device 110(1). When the agent response state is interrupted, the contact center server 150 may change the state indicator of the multimodal communication session to the customer message state. The contact center server 150 may also determine that the agent response state is interrupted upon receiving transcribed text of the voice message from the ASR engine 192.

Further, at step 324, when the contact center server 150 provides the audio of the textual response to the customer device 110(1), the contact center server 150 changes the state indicator of the multimodal communication session to the audio play state.

In the audio play state, the contact center server 150 orchestrates the multimodal communication session based on the rules corresponding to the audio play state. In one example rule, at step 324, when the communication state is in the audio play state, the contact center server 150 provides instructions to the agent device 130(1) based on which the agent device 130(1) renders an indication in the agent GUI 132 of the agent device 130(1) that the audio of the textual response is provided or being provided to the customer device 110(1). In one example, the agent GUI 132 may include an icon with the three communication states: agent response, audio play, and customer message, and the icon may display a current state of the multimodal communication session.

The customer at the customer device 110(1) may barge-in when the contact center server 110(1) is providing the audio of the textual response to the customer device 110(1). In one example rule, if the barge-in is disabled, the contact center server 150 continues playing the audio of the textual response to the customer device 110(1). In another example rule, if the barge-in is enabled, the contact center server 150 stops playing the audio of the textual response, changes the state indicator of the multimodal communication session to the customer message state, and receives a second voice message provided by the customer message during the barge-in. If the customer barges-in, the contact center server 150 provides instructions to the agent device 130(1) based on which the agent device 130(1) renders an indication in the agent GUI 132 of the agent device 130(1) that the textual response provided by the human agent was not completely played to the customer device 110(1).

Using the state signaling protocol helps, for example, provide indicators to the plurality of agent devices 130(1)-130(n) about the state of the multimodal communication session, avoid cross talk, and also enables effective implementation of the methods described herein. In one example, the communication states and rules may be configured at design time by an administrator. Although three communication states and the corresponding rules are illustrated, it may be understood that there may be other types and/or numbers of communication states and rules.

The contact center server 150 may tag one or more on-going or completed communication sessions with attributes such as “voice,” “chat,” or “multimodal,” although the communication sessions may be tagged with other types and/or numbers of attributes in other examples. When the contact center server 150 orchestrates multimodal communication session, the communication session may be tagged as “multimodal.” The contact center server 150 may tag one or more agents with attributes such as “voice,” “chat,” or “multimodal.” It may be understood that the contact center server 150 may use other types and/or numbers of attributes in other examples. The contact center server 150 may take routing decisions to the one or more agent devices 130(1)-130(n) based on these tags. In one example, the contact center server 150 may be configured to establish the multimodal communication session for multimodal conversation only with the agents who have been tagged with an attribute as “multimodal.” In one example, only one multimodal conversation may be handled by a human agent at any given point. Human agents handling multimodal conversations will be considered as busy by the contact center server 150 for all other conversations.

Having thus described the basic concept of the invention, it will be rather apparent to those skilled in the art that the foregoing detailed disclosure is intended to be presented by way of example only, and is not limiting. Various alterations, improvements, and modifications will occur and are intended for those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method comprising:
providing, by a contact center server, as part of a voice conversation with a customer device, a first voice prompt to the customer device comprising: an indication of unavailability of any voice agent at any of a plurality of agent devices and an option to route the voice conversation to any available one of a plurality of chat agents at one of the plurality of agent devices;
receiving, by the contact center server, a confirmation from the customer device to route the voice conversation to any available one of the plurality of chat agents;
establishing, by the contact center server, in response to the received confirmation a multimodal communication session between the customer device and one of the available ones of the plurality of chat agents at the one of the plurality of agent devices;
orchestrating, by the contact center server, a multimodal conversation in the multimodal communication session comprising: speech-to-text conversion of one or more customer messages received from the customer device, and text-to-speech conversion of one or more agent messages received from the one of the available ones of the plurality of chat agents at the one of the plurality of agent devices.

2. The method of claim 1, further comprising providing a second voice prompt to the customer device indicating that an audio of the one or more agent messages provided to the customer device is an output of the text-to-speech conversion.

3. The method of claim 1, further comprising providing synthesis information for the text-to-speech conversion based on analyzing a transcript of the multimodal conversation.

4. The method of claim 1, wherein the orchestration is performed based on a plurality of multimodal conversation states comprising:
an agent response state when the one or more agent messages are being typed by the one of the available ones of the plurality of chat agents at the one of the plurality of agent devices.
an audio play state when the one or more agent messages are being played to the customer device; and
a customer message state when the one or more customer messages are being provided at the customer device.

5. The method of claim 1, wherein the one or more customer messages are translated to match a language of the one or more agent messages, and the one or more agent messages are translated to match a language of the one or more customer messages.

6. A contact center server comprising:
one or more processors; and
a memory coupled to the one or more processors which are configured to execute programmed instructions stored in the memory to:
provide as part of a voice conversation with a customer device, a first voice prompt to the customer device comprising: an indication of unavailability of any voice agent at any of a plurality of agent devices and an option to route the voice conversation to any available one of a plurality of chat agents at one of the plurality of agent devices;
receive a confirmation from the customer device to route the voice conversation to any available one of the plurality of chat agents;
establish in response to the received confirmation a multimodal communication session between the customer device and one of the available ones of the plurality of chat agents at the one of the plurality of agent devices;
orchestrate a multimodal conversation in the multimodal communication session comprising: speech-to-text conversion of one or more customer messages received from the customer device, and text-to-speech conversion of one or more agent messages received from the one of the available ones of the plurality of chat agents at the one of the plurality of agent devices.

7. The contact center server of claim 6, wherein the one or more processors are further configured to execute programmed instructions stored in the memory to provide a second voice prompt to the customer device indicating that an audio of the one or more agent messages provided to the customer device during the multimodal conversation is an output of the text-to-speech conversion.

8. The contact center server of claim 6, wherein the one or more processors are further configured to execute programmed instructions stored in the memory to provide synthesis information for the text-to-speech conversion based on analyzing a transcript of the multimodal conversation.

9. The contact center server of claim 6, wherein the orchestration is performed based on a plurality of multimodal conversation states comprising:
an agent response state when the one or more agent messages are being typed by the one of the available ones of the plurality of chat agents at the one of the plurality of agent devices.
an audio play state when the one or more agent messages are being played to the customer device; and
a customer message state when the one or more customer messages are being provided at the customer device.

10. The contact center server of claim 6, wherein the one or more customer messages are translated to match a language of the one or more agent messages, and the one or more agent messages are translated to match the language of the one or more customer messages.

11. A non-transitory computer readable medium storing instructions which when executed by one or more processors, causes the one or more processors to:
provide as part of a voice conversation with a customer device, a first voice prompt to the customer device comprising: an indication of unavailability of any voice agent at any of a plurality of agent devices and an option to route the voice conversation to any available one of a plurality of chat agents at one of the plurality of agent devices;
receive a confirmation from the customer device to route the voice conversation to any available one of the plurality of chat agents;
establish in response to the received confirmation a multimodal communication session between the customer device and one of the available ones of the plurality of chat agents at the one of the plurality of agent devices;
orchestrate a multimodal conversation in the multimodal communication session comprising: speech-to-text conversion of one or more customer messages received from the customer device, and text-to-speech conversion of one or more agent messages received from the one of the available ones of the plurality of chat agents at the one of the plurality of agent devices.

12. The non-transitory computer readable medium of claim 11 further comprises: provide a second voice prompt to the customer device indicating that an audio of the one or more agent messages provided to the customer device during the multimodal conversation is an output of the text-to-speech conversion.

13. The non-transitory computer readable medium of claim 11 further comprises: provide synthesis information for the text-to-speech conversion based on analyzing a transcript of the multimodal conversation.

14. The non-transitory computer readable medium of claim 11, wherein the orchestration is performed based on a plurality of multimodal conversation states comprising:
an agent response state when the one or more agent messages are being typed by the one of the available ones of the plurality of chat agents at the one of the plurality of agent devices.
an audio play state when the one or more agent messages are being played to the customer device; and
a customer message state when the one or more customer messages are being provided at the customer device.

15. The non-transitory computer readable medium of claim 11, wherein the one or more customer messages are translated to match a language of the one or more agent messages, and the one or more agent messages are translated to match the language of the one or more customer messages.
